(19) United States
(12) Patent Application Publication
(10) Pub. No.: US 2006/0119101 A1
(43) Pub. Date: Jun. 8, 2006

(54) Pipe having enlarged and reduced diameters, and ejector using thereof

(76) Inventors: Yukio Suzuki, Gifu (JP); Masayuki Nakamura, Gifu (JP)

Correspondence Address: CANTOR COLBURN, LLP, 55 GRIFFIN ROAD SOUTH, BLOOMFIELD, CT, 06002, US

(21) Appl. No.: 11/270,255

(22) Filed: Nov. 9, 2005

(30) Foreign Application Priority Data
Nov. 9, 2004 (JP) 2004-324904

(51) Int. Cl. F16L 21/00

(52) U.S. Cl. 285/399

(57) ABSTRACT

A pipe may have enlarged and reduced diameters, which has low costs and which can prevent leakage of a fluid such as a refrigerant from the pipe even in such a configuration that a reduced diameter portion is continuous to an enlarged diameter portion continuous to another reduced diameter portion, the pipe being integrally and continuously formed by plastic or malleable working so as to having outer diameters (D1 . . . D8) which are longitudinally different from one another, and accordingly, the reduced diameter portion (1b-1c) being continuous to the enlarged diameter portion (1c-1d) which is continuous to another reduced diameter portion (1d-1e).

### CROSS REFERENCE TO RELATED APPLICATION

The present invention claims priority under 35 U.S.C. §119 to Japanese Application No. 2004-324904 filed Nov. 9, 2004, which is incorporated herein by reference.

### BACKGROUND OF THE INVENTION

The present invention may relate to a pipe made with copper, brass, bronze, stainless steel, aluminum or other metals or other metals having enlarged and reduced diameters which may be used in a pipe line for a heat-exchanger and in pipe line constituting units, and which have diameters that are optionally different in its longitudinal direction with no leakage of refrigerant, and an ejector which is manufactured with use of excellent properties thereof and which is appropriate for a special expansion valve in a refrigeration cycle.

A pipe line for a heat-exchanger or units constituting a pipe line is adapted to circulate a refrigerant in a closed loop system so as to cause heat transmission, and accordingly, it is very important to prevent leakage of the refrigerant from the closed loop system in view of thermal efficiency, resource saving and environmental protection.

Meanwhile, among the above-mentioned units including a heat-exchanger constituting a pipe line, the one which has to optionally enlarge and reduce the diameter of the pipe line. Conventionally, the enlarged and reduced diameter configuration has been formed by cutting a material block or by welding or brazing pipes having different diameters to one another.

The one formed by cutting would cause high costs while the one formed by welding or the like causes a risk of leakage of a refrigerant through its joint, and additionally requires welding costs.

In order to solve the above-mentioned problems, the applicant has proposed the so-called intermediately reduced diameter pipe in Japanese Patent Laid-Open No. 2003-148659 (Refer to in particular FIGS. 2 and 3) and Japanese Patent Laid-Open No. 2004-44886 (Refer to in particular FIG. 2). FIG. 5 shows an intermediately reduced diameter pipe disclosed in the Japanese Patent Laid-Open No. 2004-44886.

The intermediately reduced diameter pipe 10 is integrally formed by plastic working from a continuous single pipe material, without being cut, and is composed of a large diameter portion 10a, a middle diameter portion 10b, a small diameter portion 10c, a middle diameter portion 10d and a large diameter portion 10e which are arranged from one end to the other end thereof, the middle diameter portions 10b, 10d having outer diameters or pipe diameters which are smaller than that of the large diameter portions 10a, 10e while the small diameter portion 10c has an outer diameter or a pipe diameter which is smaller than that of the middle diameter portions 10b, 10d.

Thus, the above-mentioned intermediately reduced diameter pipe 10, in particular, having a certain portion which has a length sufficiently long in comparison with the outer diameter thereof, for example, the small diameter portion 10c (which has a wall thickness of 0.6 mm, an outer diameter of 2.4 mm, and a maximum length of 70 mm, as disclosed in the Japanese Patent Laid-Open No. 2003-148659) can be integrally formed by continuous plastic working although it has been conventionally difficult to be formed thereby, and can completely eliminate leakage of a refrigerant, thereby it is possible to preferably use the intermediately reduced diameter pipe for an expansion valve in a refrigeration cycle as disclosed in the Japanese Patent Laid-Open No. 2003-148659.

Further, in the intermediately reduced diameter pipe 10, the large diameter portion 10a is formed in part with an orthogonal opening 10f in a direction orthogonal to its pipe axis by plastic working. This configuration is distinctive in the Japanese Patent Laid-Open No. 2004-44886 in comparison with the Japanese Patent Laid-Open No. 2003-148659, that is, with the provision of the orthogonal opening 10f, it is possible to avoid causing complication or increasing costs since a T-fitting pipe is connected thereto in order to attach thereto an equipment for measuring a pressure of a refrigerant or a branch. Further, a number of joint parts where brazing is made may be reduced so as to be preferable for preventing leakage of a refrigerant.

However, the above-mentioned intermediately reduced diameter pipe 10 has been unable to be used in an ejector as a special expansion valve which is used in a refrigeration cycle and which requires a part having a continuously reduced diameter for further reducing the pipe diameter in a diameter enlarged part between the small diameter portion 10c and the large diameter portion 10a.

Meanwhile, Japanese Patent Laid-Open No. H11-257298 (Refer to in particular, FIGS. 1 to 3) and Japanese Patent Laid-Open No. 2003-326196 (Refer to in particular to FIG. 4) disclose methods of forming an ejector.

The Japanese Patent Laid-Open No. H11-257298 discloses a method in which a pipe line configuration required for an ejector is formed in its entirety at one time. The pipe line configuration is formed in such a way that bisplit shapes obtained by bisplitting the pipe line configuration along the pipe line axis, are concavely formed by plastic working, respectively in two planar plates which are then joined to each other, resulting in increase in manufacturing costs thereof and occurrence of a problem of leakage through the joint which is long along the entire length of the pipe line configuration.

The Japanese Patent Laid-Open No. 2003-326196 discloses a method in which the diameter of a pipe material is enlarged or reduced by plastic working while the pipe material is rotated. In the case of requiring a core in the pipe in order to obtain a required shape, it is impossible to reduce the diameter thereof after it is enlarged. Further, a range where it may be integrally formed is limited so as to inevitably utilize a local joint part, thereby a problem of leakage, a problem of cost-up and the like have been similarly caused.

Further, Japanese Patent No. 3,322,263 (Refer to in particular FIG. 1) discloses an EJECTOR CYCL™ in which an ejector is effectively used in a refrigeration cycle in order to enhance performance factors of the refrigeration cycle. However, this document fails to disclose the ejector which is formed of a pipe having enlarged and reduced diameters, which is continuously and integrally formed.

### BRIEF DESCRIPTION OF THE INVENTION

The present invention may solve the above-mentioned problems, and accordingly, the present invention may provide a pipe made with copper, brass, bronze, stainless steel, aluminum or other metals having enlarged and reduced diameters, which has reduced costs and which may prevent leakage of a fluid such as a refrigerant from the pipe even though it has a reduced diameter portion continuous to an enlarged portion continuous to another reduced diameter portion, and to provide an ejector which may utilize the property thereof.

There may be provided a pipe having enlarged and reduced diameters, which is continuously and integrally formed by plastic or malleable working so as to have different outer diameters in a longitudinal direction thereof, having an enlarged diameter portion continuous to a reduced diameter portion is further provided thereto with a reduced diameter portion continuous thereto.

There may be provided a pipe having enlarged and reduced diameters, comprising the pipe having a large diameter portion and small diameter portions with smaller inner diameters, provided on opposite sides of the former, incorporates therein a component having larger than the inner diameters of the small diameter portions.

There may be provided a pipe having enlarged and reduced diameters, comprising the pipe has a constant outer diameter portion formed therein with an orthogonal opening which is orthogonal to a direction of a pipe axis of the pipe.

Further, there may be provided an ejector comprising a pipe having enlarged and reduced diameters as stated in the first or third aspect of the present invention, is used.

In view of embodiments of claims 1 to 3, there may be provided the pipe made with copper, brass, bronze, stainless steel, aluminum or other meals or other metals having enlarged and reduced diameters which is integrally and continuously formed by plastic or malleable working so as to have different diameters in the longitudinal direction thereof, the reduced diameter portion being provided, continuous to the enlarged diameter portion continuous to another reduced diameter portion, which has low costs, and which can prevent leakage of a fluid such as a refrigerant from the pipe although the reduced diameter portion is continuous to the large diameter portion continuous to another small diameter portion.

The embodiment of ejector as stated in claim 4, which utilizes the pipe having enlarged and reduced diameters according to any one of embodiments of claims 1 or 3, may exhibit technical effects and advantages owned by the pipe.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a longitudinal sectional view conceptually illustrating an embodiment of a pipe having enlarged and reduced diameters;

FIG. 2a is a longitudinal sectional view conceptually illustrating a pipe having enlarged and reduced diameters in another embodiment;

FIG. 2b is a longitudinal sectional view conceptually illustrating a pipe having an enlarged and reduced diameters in further another embodiment;

FIG. 3a is a longitudinal sectional view illustrating an ejector in an embodiment;

FIG. 3b is a sectional view along line A-A in FIG. 3a;

FIG. 4 is a longitudinal view illustrating an ejector in another embodiment; and

FIG. 5 is a perspective view illustrating an example of a conventional pipe having enlarged and reduced diameters.

### DETAILED DESCRIPTION OF THE INVENTION

Explanation will be herein below made of preferred embodiments of the present invention with reference to the accompanying drawing.

### Embodiment 1

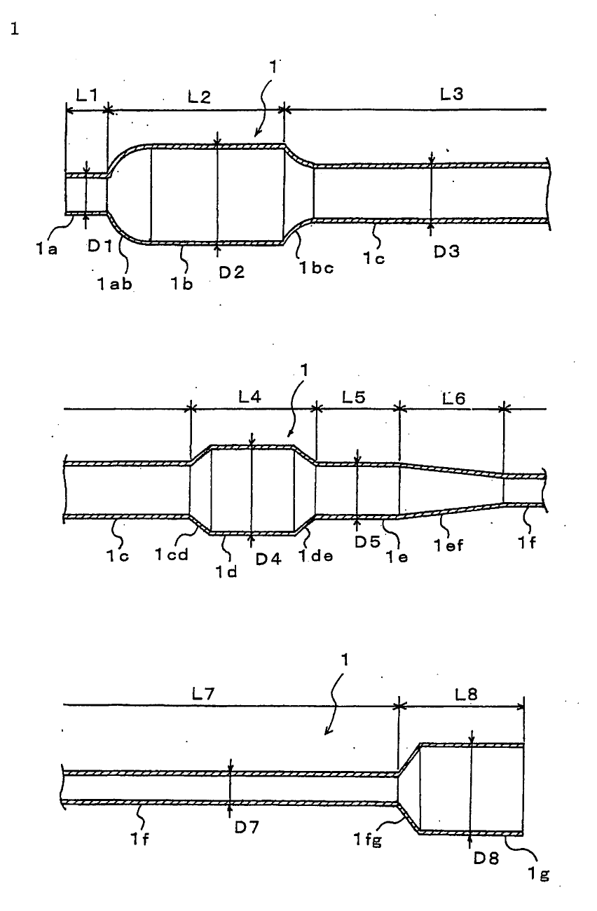

FIG. 1 is a longitudinal sectional view which conceptually shows an example of a pipe made with copper having enlarged and reduced diameters according to an embodiment of the present invention.

The pipe 1 having enlarged and reduced diameters is integrally formed by plastic or malleable working, from a singe continuous pipe material having no joint and welding, and is a conceptual example of the configuration of a pipe having enlarged and reduced diameters, which may be formed by the plastic or malleable working.

Thus, the above-mentioned pipe may not always be applied in a specific industrially applicable field but in such an industrially applicable field as to require a pipe having enlarged and reduced diameters, which may prevent leakage of a fluid flowing through the pipe, and which has been conventionally formed by welding, grinding or cutting since it has not been unable to be formed by plastic or malleable working which has been although desirable. In a specific example, the pipe may be preferably used in an ejector which is a specific expansion valve used as an element of a refrigeration cycle, as will be described later.

The pipe having enlarged and reduced diameters 1 is composed of a small diameter portion 1a, a large diameter portion 1b connected thereto, and also a small diameter portion 1c, a large diameter portion 1d, a middle diameter portion 1e, a small diameter portion 1f and a large diameter portion 1g which are connected to one another through the intermediary of transient portions 1ab, 1bc, 1cd, 1de, 1ef, 1fg, respectively.

As clearly understood from FIG. 1, the pipe 1 having enlarged and reduced diameters is different from a conventional one in view the provision of a reduced diameter portion (for example, the large diameter portion 1d, the middle diameter portion 1e and the small diameter portion 1f) continuous to the an enlarged diameter portion (between the small diameter portion 1c and the large diameter portion 1d) which is further continuous to the reduced diameter portion (for example, between the large diameter portion 1b and the small diameter portion 1c). From this configuration, it is understandable to accept any of various conditions as to enlarged and reduced diameters in comparison with the conventional one.

Further, as shown in the figure, the small diameter portion 1a, the large diameter portion 1b (including the transient parts 1ab, 1bc on opposite sides thereof), . . . respectively have lengths L1, L2, . . . L8 (It is noted that L6 is the length of the transient portion lef alone) in succession, and outer diameters D1, D2, . . . D8 (except the transient portion lef) in succession.

The outer diameters D1 to D8 of the pipe 1 may accept those which are practically and industrially demanded within a range which is allowable in view of a standard size and a capacity of a working facility. The outer diameters falls as actual results used for heat-exchangers up to now in a range from 2.4 to 16 mm, the wall thicknesses of the pipe in a range from 0.6 to 1.2 mm. As a result, the inner diameter of the small diameter portion may have a minimum diameter down to about 0.1 mm

The lengths L1 to L8 may also accept those which are practically and industrially demanded within a range which is allowable in view of a standard size and a capacity of a working facility, and falls as actual results used for heat-exchangers up to now in a range from 0 to 700 mm.

These lengths L1 to L8 are not substantially limited, that is, may accept those which are practically and industrially demanded, and this point is different from pipes having enlarged and reduced diameters which have been conventionally provided. Further, the lengths L1 to L8 may be set to any length required by the industrial demand even for a transient part in which the outer diameter varies, for example, the transient part lef as shown.

Further, the shape of this transient part should not be limited to a linear slope, but may be curve-like as in the transient part 1ab or 1bc, and further, the length thereof should not be limited to a specific one.

### Embodiment 2

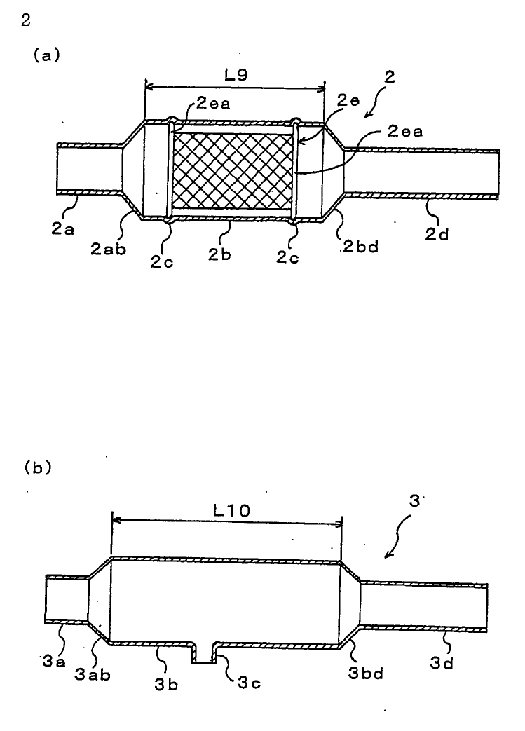

FIG. 2a is a longitudinal portional view which conceptually shows another example of the pipe having enlarged and reduced diameters according to the present invention. It is noted that the pipe 1 having enlarged and reduced diameters will be explained with the use of reference numerals different from those used in FIG. 1. However, the basic configuration thereof and technical effects and advantages obtained thereby are similar to those of the pipe 1 having enlarged and reduced diameters in FIG. 1.

The pipe 2 having enlarged and reduced diameters has the same configuration as that of the pipe 1 having enlarged and reduced diameters shown in FIG. 1, except that it has only one large diameter portion 2b, and small diameter portions 2a, 2d having smaller outer diameters are provided on opposite sides of the large diameter portion 2b through the intermediary of transient parts 2ab, 2ad connected therebetween.

The large diameter portion 2b is accommodated and fixed therein with a component 2e which has an outer diameter larger than inner diameters of the small diameter portions 2a, 2d, and which may be accommodated in the bore of the large diameter portion 2b, so that the component 2e is not movable in the direction of the pipe axis. This component 2e may be, in a specific form, a filter or catalyst which acts upon a fluid flowing through the pipe 2.

The component 2e may be fixed by fitting a circular outer peripheral edges of opposite end discs 2ea, in enlarged convex parts 2c which are formed in the large diameter portions 2b, which correspond thereto and which may be provided as one pattern of enlarged and reduced diameters of the pipe having enlarged and reduced diameters according to the present invention. With this configurations, these parts may be formed as parts of an integral body formed by plastic or malleable working even in such a case that the large diameter portion is incorporated therein with a component having a diameter which are larger than that of the small diameter portions on opposite side of the large diameter portion. Thereby it is possible to provide a pipe having enlarged and reduced diameters which may completely prevent external leakage of a fluid flowing through the pipe, and further, which may have manufacturing costs inexpensive in comparison with a pipe formed by welding or brazing.

The above-mentioned component 2e may be formed, fixed and accommodated by the following steps which will be explained so that the plastic or malleable working of the pipe 2 is generally carried out one by one from the right side to the left side of the figure.

First, plastic or malleable working for the left end reduced diameter portion 2a is carried out, and the plastic or malleable working of the transient part 2ab and the larger diameter portion 2b up to the enlarged diameter convex part 2c of the large diameter portion 2b is carried out. Further, the plastic or malleable working is carried out up to the large diameter portion in the half part on left side of the enlarged diameter convex part 2c. In this condition, the component 2e is inserted in a not-worked part on the right side of the pipe 2 (the outer diameter thereof is equal to the maximum outer diameter of the enlarged convex part 2c)

The left side disc 2ea is fitted in and made into contact with the worked part of the enlarged convex part 2c, and then the plastic or malleable working of a remaining reduced diameter part of the left side enlarged convex part 2c is successively carried out. Further, the plastic or malleable working of the large diameter portion 2b between both left and right side enlarged convex part 2c, and the plastic or malleable working of the right side enlarged convex part 2c is carried out. Then, the remaining right side large diameter portion 2b, the transient part 2bd and the small diameter portion 2d is carried out.

### Embodiment 3

FIG. 2b is a longitudinal portion view which conceptually shows another example of the pipe having enlarged and reduced diameters according to an embodiment of the present invention.

The pipe 3 having enlarged and reduced diameters has the same configuration as that of the pipe 1 having enlarged and reduced diameters in FIG. 1, except that only one large diameter portion is formed and small diameter portions 3a, 3d having smaller diameters are connected thereto on both sides thereof through the intermediary of transient parts 3ab, 3ad therebetween.

The large diameter portion 3b is formed therein with an orthogonal opening 3c which is opened in a direction orthogonal to the pipe axis.

The orthogonal opening 3c is similar to the orthogonal opening 10f in the pipe 10 having enlarged and reduced diameters shown in FIG. 5 as a conventional example, and may exhibit technical effects and advantages similar to those of the opening 10f. That is, it may avoid complication and cost up caused by connection of a T-fitting pipe for attachment of a measuring unit for measuring, for example, a pressure of a refrigerant or for provision of a branch, and further, it may reduce the number joint parts such as brazed parts, thereby it is possible to effectively prevent leakage of the refrigerant.

In addition, in the case of this pipe 3 having enlarged and reduced diameters, no opening like the pipe 10 having enlarged and reduced diameters in FIG. 5 is formed on one side of the large diameter portion 3b formed therein the orthogonal opening 3c but the small diameter portion 3a or 3d are joined thereto, and accordingly, the part provided with the orthogonal opening 3c, may accept any of various demands.

### Embodiment 4

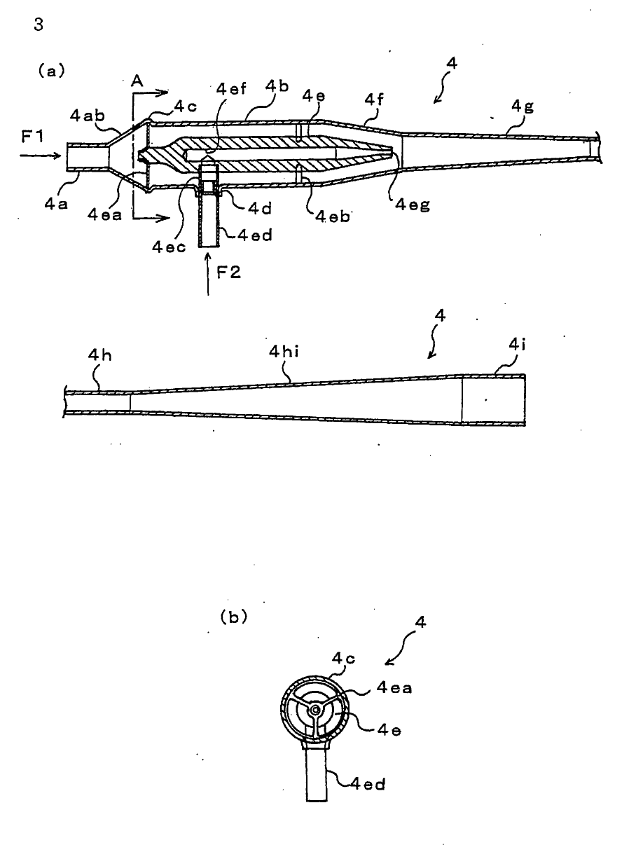

FIG. 3a is a longitudinal portional view illustrating an example of an ejector according to the present invention, and FIG. 3b is a portional view along line A-A in FIG. 3a.

Explanation will be hereinbelow made of the ejector which is used in a refrigeration cycle and in which the properties of the pipe having enlarged and reduced diameters according to the present invention are effectively used.

It is noted here that the ejector is the one which is the so-called jet pump or an ejector pump (JISZ8126-2.1.2.2), that is, a momentum transfer type vacuum pump which carries a gas on a high velocity stream, which has an expansion nozzle structure with no movable part, as a basic element. With the use of the ejector instead of a conventional expansion valve, there may be materialized the so-called ejector cycle™ which may enhance the efficiency of a refrigeration cycle used in an air-conditioner or a refrigerator.

However, in comparison with a configuration of the conventional expansion valve, it is required that the ejector may not only prevent leakage of a refrigerant but also a pipe having enlarged and reduced diameters may have various enlarged and reduced diameters, that is, an enlarged diameter portion continuous to a small diameter portion is continuous thereto with another reduced diameter portion. Thus, the pipe having enlarged and reduced diameters of this invention may be preferably used therefor.

The ejector 4 is constituted, as stated above, by the pipe having enlarged and reduced diameters, which has been explained hereinabove. Referring to FIG. 3a, the ejector 4 is composed of a small diameter portion 4a, an enlarged diameter transient portion 4ab, a large diameter portion 4b, a reduced diameter transient portion 4f having a linear slope, a reduced diameter transient portion 4g continuous to the portion 4f, having a moderate linear slope, a small diameter portion 4h, an enlarged diameter transient portion 4hi having a linear slope, and a middle diameter portion 4i, which portions are arranged rightward from the left side of FIG. 3a.

The large diameter portion 4b accommodates therein a cylindrical component 4e opened rightward of the figure in a nozzle-like manner and having sharpened opposite end parts. The left end part of the component 4e is diametrically and longitudinally fixed by a disc 4ea enlarged convex parts 4c of the large diameter portion 4b, similar to the configuration shown in FIG. 2a, and the right side part thereof is fixed by a disc 4eb having a diameter equal to the inner diameter of the large diameter portion 4b so as to be diametrically unmovable.

Further, the large diameter portion 4b is formed therein with an orthogonal opening 4d, similar to that shown in FIG. 2b, which is connected thereto with an external pipe 4ed extended outward, and an internal pipe 4ec connecting the external pipe 4ed with an internal passage 4ef that is communicated with the above-mentioned nozzle-like opening 4eg of the component 4e accommodated in the large diameter portion 4b so as to ensure a passage from the external pipe 4ed to the nozzle-like opening 4eg of the component 4e accommodated in the large diameter portion 4b.

This ejector 4 is used as a part of a circulation passage of the refrigeration cycle, that is, a gas refrigerant F1 is fed to the left side end small diameter portion 4a while a liquid refrigerant F2 is fed in the external pipe 4ed connected to the orthogonal opening 4d in the large diameter portion 4b, and accordingly, the gas refrigerant F1 flows around the component 4e in the large diameter portion 4b and merges at the nozzle-like opening 4eg of the component 4e with the liquid refrigerant F2 which is fed orthogonal to the large diameter portion 4b, passing through the internal passage 4ef of the component 4e, and which is then jetted. Thus, the refrigerants are efficiently expanded, accelerated and boosted up during passing through the reduced diameter transient portion 4g, the small diameter portion 4h, the enlarged diameter transient portion 4hi and the middle diameter portion 4i. That is, the ejector may exhibit the functions of an expansion valve and a diffuser in the refrigeration cycle.

It may be considered that the above-mentioned efficiency is obtained by the ejector having the configuration and the structure according to the present invention since the ejector causes less eddy currents,

In order to effectively achieve the above-mentioned functions, it is desired to allow the ejector 4 to have the configuration as shown, and accordingly, with the use of the pipe having enlarged and reduced diameters, according to the present invention, the above-mentioned configuration may be integrally formed by plastic or malleable working. Thus, it may be manufactured at low costs and may reduce the number of joint parts which causes leakage, thereby it is possible to reduce external leakage of a refrigerant as far as possible.

Further, since the pipe is formed by plastic or malleable working and has a uniform wall thickness, it is possible to enhance the pressure resistance (specifically about 2352 MPA (240 kgf/cm2)) of parts other than joint parts, and accordingly, the pipe may be used for a natural refrigerant such as a carbonic gas (CO2) which requires a higher pressure.

The number of joint parts may be reduced, and the configuration of the joint parts may be such that cylindrical parts are fitted together by using the orthogonal opening formed by plastic or malleable working, and accordingly, joining such as brazing may be easily made so as to reduce leakage, thereby it is advantageous in view of the pressure resistance.

It is noted that the dimensions of the parts of the ejector 4, such as the inner diameters and lengths of the reduced diameter transient portion 4g and the small diameter portion 4h may be suitably set in accordance with a king of a refrigerant used in the ejector 4 and a required refrigerating capacity.

### Embodiment 5

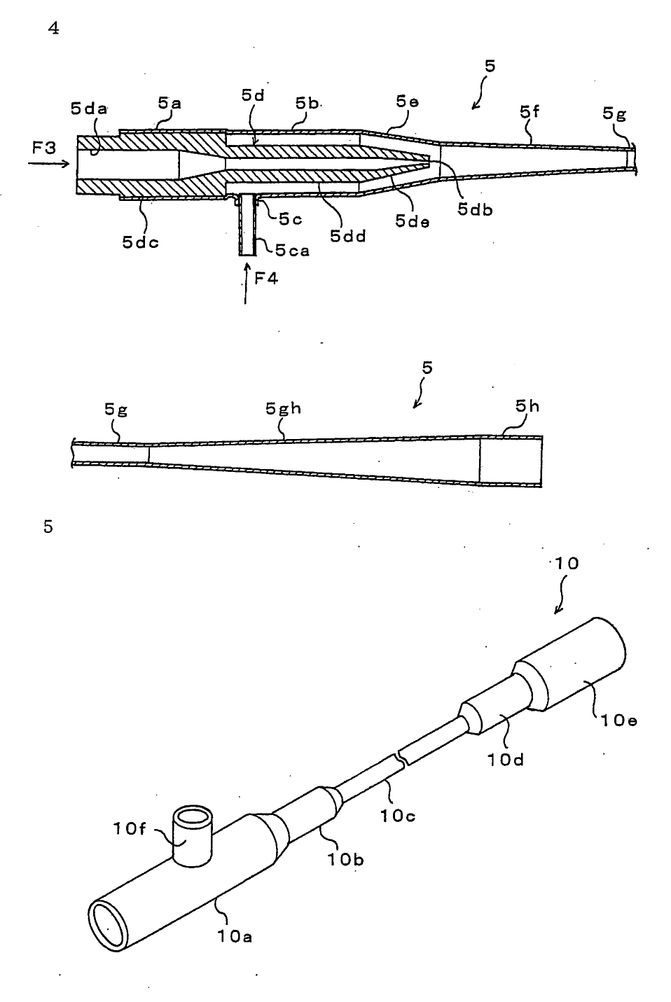

FIG. 4 is a longitudinal view illustrating an ejector in another embodiment of the present invention.

An ejector 5 utilizes the properties of the pipe having enlarged and reduced diameters according to the present invention, similar to the ejector 4 shown in FIG. 3, having the same configuration as that of the latter, except that a large diameter portion 5a is used at the left end, instead of the small diameter portion. Similar to the ejector 4 having the large diameter portion 4b, the reduced diameter transient portion 4f, 4g, the small diameter portion 4h, the enlarged diameter transient portion 4hi and the middle portion 4i, the ejector 5 has a large diameter portion 5b having a slightly smaller diameter, continuous to the large diameter portion 5a, reduced diameter transient portions 5e, 5f continuous to the large diameter portion 5b, a small diameter portion 5g, an enlarged diameter transient portion 5gh and a middle diameter portion 5h.

A component 5d is fitted in the left end large diameter portion 5a with no gap. An orthogonal opening 5c is formed at a predetermined position in the large diameter portion 5b adjacent to the large diameter portion 5b, and is jointed thereto with an external pipe 5ca extending outward from the large diameter portion 5b.

The component 5d is cylindrical, having two stage outer diameters, and comprises a large diameter part 5dc fitted in the bore of the large diameter portion 5a on the pipe side, a small diameter part 5dd having such an outer diameter that it defines a uniform cylindrical space with respect to the bore of the large diameter portion 5b on the pipe side, and a conical projecting part 5de rightward of the small diameter part.

A part of the large diameter part 5dc of the component 5d is exposed leftward from the part which is fitted in the large diameter portion 5a on the pipe side. Further, the component 5d is formed therein with a nozzle-like passage 5da having a diameter reduced toward its forward end which has a nozzle opening 5db formed in the above-mentioned projecting part 5de.

The forward end of the external pipe 5ca joined to the orthogonal opening 5c is not projected up to the inner periphery of the large diameter portion 5b, and accordingly, a gas refrigerant F4 fed through the external pipe 5ac is led in the cylindrical space between the component 5d and the large diameter portion 5b.

This ejector 5 is also used as a part of a circulation passage of a refrigeration cycle, and in this case, a liquid refrigerant F3 is fed to a passage 5da in the left and part of the component 5d while the gas refrigerant F4 is fed through the external pipe 5ca which is fitted in the orthogonal opening 5c.

Further, the gas refrigerant F4 flowing around the component 5d in the large diameter portion 5b merges at the nozzle opening 5db in the component 5d with the liquid refrigerant F3 which is jetted from the opening 5db so as to be efficiently expanded, accelerated and boosted up during passing through the reduced diameter transient portion 5f, the small diameter portion 5g, the enlarged diameter transient portion 5gh and the middle diameter portion 5h, thereby it is possible to exhibit functions of an expansion valve and a diffuser in the refrigeration cycle. Thus, it is possible to exhibit technical effects and advantages similar to those exhibited by the ejector 4.

The pipe having enlarged and reduced diameter according to the present invention may be preferably used in any of various industrial fields which requires such a condition that a fluid which may flows in a pipe line may be inhibited from leaking outside from the pipe line, and diameters may be optionally set at longitudinal positions.

The ejector according to the present invention may be appropriately used in a refrigeration cycle in a refrigerator, an air-conditioner, a water heater or the like.

While the preferred embodiments of the present invention have been described using specific terms, such description is for illustrative purposes only, and it is to be understood that changes and variations may be made without departing from the spirit or scope of the appended claims.

What is claimed is:

1. A pipe having enlarged and reduced diameters, integrally formed by plastic or malleable working so as to longitudinally have different diameters, comprising:
a diameter reduced portion which is continuous to an enlarged diameter portion continuous to another reduced diameter portion.

2. A pipe having enlarged and reduced diameters according to claim 1, further comprising:
the large diameter portion of the pipe provided at its opposite ends with smaller diameter portions having smaller diameters, incorporates therein with a component larger than inner diameters of the small diameter portions.

3. A pipe having enlarged and reduced diameters according to claim 1, further comprising:
the pipe has a constant outer diameter portion formed therein with an orthogonal opening which is orthogonal to a pipe axis of the pipe.

4. A pipe having enlarged and reduced diameters according to claim 2, further comprising:
the pipe has a constant outer diameter portion formed therein with an orthogonal opening which is orthogonal to a pipe axis of the pipe.

5. An ejector comprising:
a pipe having enlarged and reduced diameters, integrally formed by plastic or malleable working so as to longitudinally have different diameters, comprising:
a diameter reduced portion which is continuous to an enlarged diameter portion continuous to another reduced diameter portion.

6. An ejector according to claim 5, further comprising:
the large diameter portion of the pipe provided at its opposite ends with smaller diameter portions having smaller diameters, incorporates therein with a component larger than inner diameters of the small diameter portions.

7. An ejector according to claim 5, further comprising:
the pipe has a constant outer diameter portion formed therein with an orthogonal opening which is orthogonal to a pipe axis of the pipe.

8. An ejector according to claim 6, further comprising:
the pipe has a constant outer diameter portion formed therein with an orthogonal opening which is orthogonal to a pipe axis of the pipe.
